(19) United States
(12) Patent Application Publication
(10) Pub. No.: US 2006/0162256 A1
(43) Pub. Date: Jul. 27, 2006

(54) Weatherstrip

(75) Inventors: Hideshi Tsuchida, Hiroshima (JP); Tsuyoshi Noda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignees: Nishikawa Rubber Co., Ltd., Hiroshima-shi (JP); Mitsubishi Jidosha Kogyo Kabushikikaisha, Tokyo (JP)

(21) Appl. No.: 11/288,524

(22) Filed: Nov. 29, 2005

(30) Foreign Application Priority Data
Jan. 27, 2005 (JP) 2005-019003

(51) Int. Cl. E06B 7/16

(52) U.S. Cl. 49/479.1; 49/489.1

(57) ABSTRACT

A weatherstrip for a hardtop automobile comprising a molded part that is attached to the corner part of the door opening edge of the body, wherein the molded part has a base that is attached to a retainer fixed to the body, sidewalls rising from the base, a sealing wall that forms a hollow together with the base and sidewalls and is resiliently pressed against the door glass when the door is closed, and a lip that is extended from the sealing wall and inserted between the body and a garnish attached to the body and a projection that makes contact with the body to support the lip is formed on the back of the lip, whereby a gap is not created between the lip and the garnish when the door is closed and the lip is pushed inward.

### CROSS-REFERENCE TO THE RELATED ART

This application incorporates by reference the subject matter of Application No. 2005-19003, filed in Japan on Jan. 27, 2005, on which a priority claim is based under 35 U.S.C. §119 (a).

### BACKGROUND OF THE INVENTION

1. Field of the Invention

The present invention relates to a weatherstrip that is attached to the door opening edge of the body side of a hardtop automobile to seal the door glass when the door is closed, and particularly relates to a weatherstrip having a molded part that is attached to the corner of the door opening edge.

2. Description of the Related Art

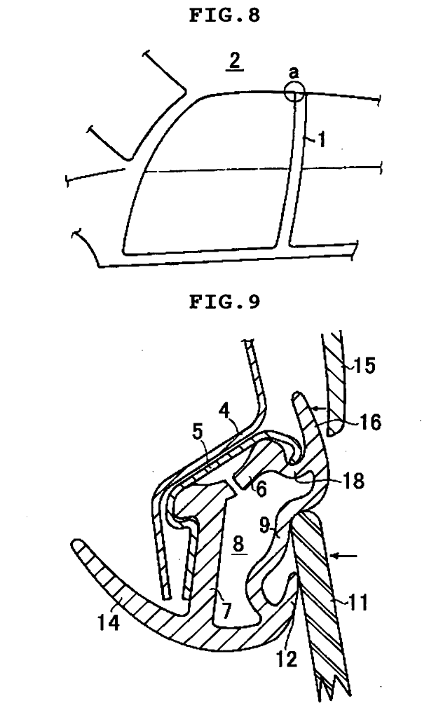

FIG. 7 shows a prior art weatherstrip having a molded part 3 that is attached to the corner a between the upper part of the center pillar 1 and the side edge of the roof 2 of a four-door type hardtop automobile as shown in FIG. 8. FIG. 9 is a cross-sectional view at the line 9-9 in FIG. 7 when the door is closed and the door glass 11 is resiliently pressed against the weatherstrip. The weatherstrip comprises a base 6 that is attached to a retainer 5 fixed to the body 4, a sidewall 7 rising from one side of the base 6, a sidewall 18 rising from the other side of the base 6, a sealing wall 9 that is formed integrally with the sidewalls 7 and 18 and forms a hollow 8 together with the base 6 and sidewalls 7 and 18, a sealing lip 12 that is resiliently pressed against the door glass 11, a cover lip 14 that covers the trimmed end of interior materials, and a lip 16 that is inserted between the body 4 and a garnish 15. The sealing wall 9 and sealing lip 12 are resiliently pressed against the door glass 11 for double sealing when the door is closed. The triangles in FIG. 7 indicate that, common with all figures, the part on the outlined side is formed by extrusion and the part on the filled side is formed by molding.

As shown in FIG. 7, the lip 16 of the weatherstrip is laterally extended from the molded part 3 attached to the corner a to fit the corner a, and is most extended at the part shown by the line 9-9. Therefore, the weatherstrip is least rigid at the tip of the most extended part on the line 9-9. When the door is closed and the door glass 11 pushes the sealing wall 9 in the direction of the arrow shown in FIG. 9, the lip 16 is also pressed in the direction of the arrow and a gap is created between the lip 16 and the garnish 15. Therefore, there are drawbacks such as defective sealing and easily impaired appearance.

The purpose of the present invention is to provide a body side weatherstrip that resolves the above problem.

### SUMMARY OF THE INVENTION

The present invention relates to a hardtop automobile weatherstrip that is attached to the door opening edge of the body to seal the door glass when the door is closed. The weatherstrip comprises a molded part that is attached to the corner part of the door opening edge of the body. The molded part has a base that is fixed to the body, with sidewalls rising from the base, a sealing wall that forms a hollow together with the base and sidewalls and is resiliently pressed against the door glass when the door is closed, and a lip that is extended from the sealing wall and inserted between the body and a garnish attached to the body. The lip has a projection, a ridge or a thicker part, which makes contact with the body to support the lip.

### BRIEF DESCRIPTION OF THE DRAWINGS

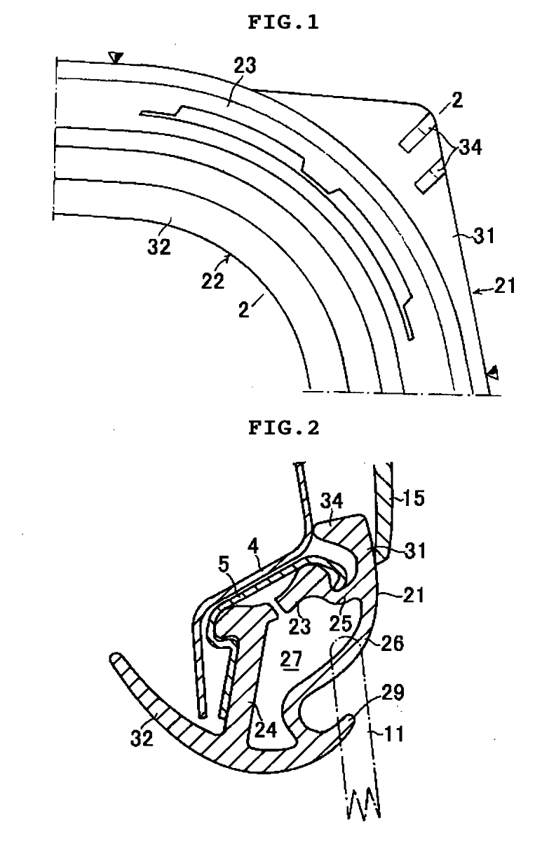

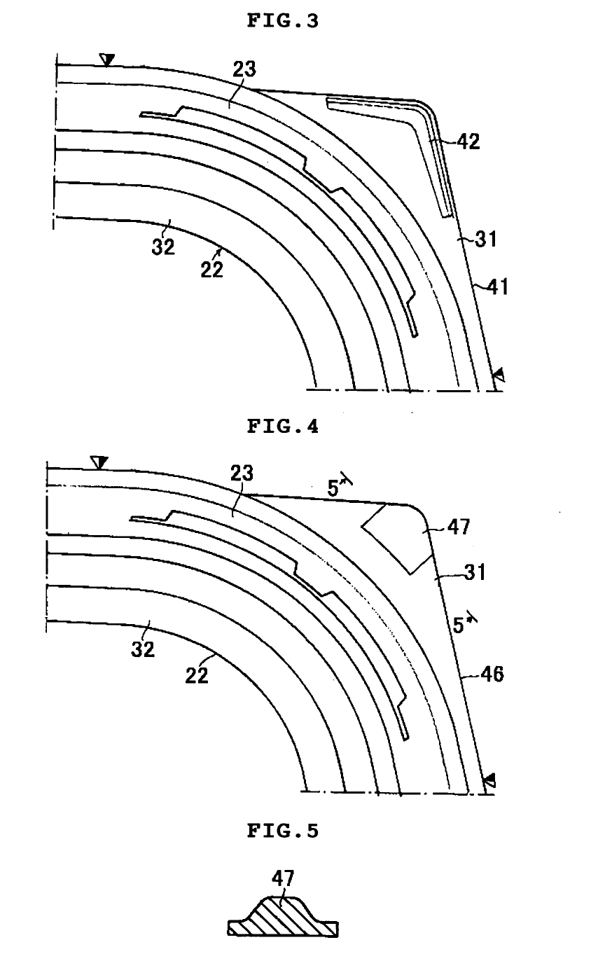

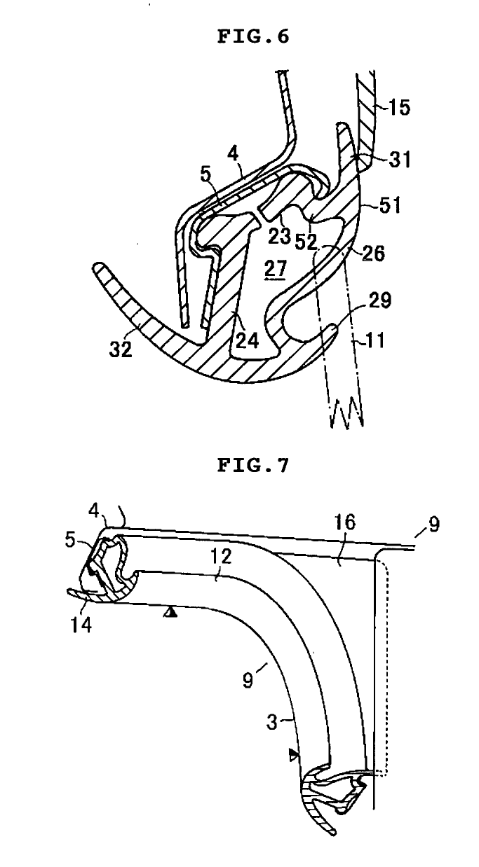

The present invention will become more fully understood from the detailed description given in below and the accompanying drawings are given by way of illustration only, and thus, are not limitative of the present invention, and wherein:

[FIG. 1] FIG. 1 is a perspective view of a molded part of the weatherstrip according to the present invention seen from the bottom.

[FIG. 2] FIG. 2 is a cross-sectional view at the line 2-2 in FIG. 1.

[FIG. 3] FIG. 3 is a perspective view of another molded part of the weatherstrip according to the present invention seen from the bottom.

[FIG. 4] FIG. 4 is a perspective view of further another molded part of the weatherstrip according to the present invention seen from the bottom.

[FIG. 5] FIG. 5 is a cross-sectional view of the line 5-5 in FIG. 4.

[FIG. 6] FIG. 6 is a cross-sectional view of further another molded part of the weatherstrip according to the present invention seen from the bottom.

[FIG. 7] FIG. 7 is an illustration to show a corner part of a door opening edge to which a body side weatherstrip is attached.

[FIG. 8] FIG. 8 is a perspective view of a part of a hardtop automobile.

[FIG. 9] FIG. 9 is a cross-sectional view at the line 9-9 in FIG. 7.

### DESCRIPTION OF THE PREFERRED EMBODIMENT

The weatherstrip according to the present invention is attached to the door opening edge of a hardtop automobile. The hardtop automobile can be of any type: a two-door type, a three-door coupe type, or a four-door type.

The weatherstrip according to the present invention has a molded part that is attached to the corner between the roof side edge and the center pillar in a two-door type or three-door coupe type automobile and to the corner between the roof side edge and the center pillar, front pillar, or rear pillar in a four-door type automobile.

FIG. 1 shows the bottom of a weatherstrip 21 according to the present invention comprising a molded part 22 that is attached to the corner a between the upper part of the center pillar 1 and the side edge of the roof 2 of a four-door type hardtop automobile similar to the prior art weatherstrip shown in FIG. 7. FIG. 2 is a cross-sectional view at the line 2-2 in FIG. 1.

The molded part 22 has a base 23 that is fixed to the body 4 by a retainer. A sealing wall 26 formed integrally with a sidewall 24 rising from one side of the base 23 and a sidewall 25 rising from the other side of the base 23 and connecting them forms a hollow 27 together with the base 23 and sidewalls 24 and 25. When the door is closed, the sealing wall 26 and a sealing lip 29 protruding outside the automobile from the sealing wall 26 are resiliently pressed against the door glass 11 for double sealing. In the figure also shown are a lip 31 that is extended from the outer perimeter of the curved molded part 22 and inserted between the body 4 and the garnish 15, and a cover lip 32 that covers the trimmed edge of un-shown internal materials.

The above molded part 22 of the weatherstrip 21 has the same structure as the aforementioned prior art weatherstrip shown in FIGS. 4 and 6. However, this is different from the prior art weatherstrip in that the lip 16 of the molded part 3 have a pair of projections 34 that is extended in the extension direction of the lip 16 to make contact with the body 4, whereby supporting the lip 16. In the shown embodiment, a pair of projections 34 is extended in the extension direction of the lip 31. However, only one projection 34 or three or more projections 34 can be provided and oriented in the intersecting direction with the extension direction of the lip 31.

In the weatherstrip 21 of this embodiment, the lip 31 is supported with the projection 34 being in contact with the body 4. Therefore, the lip 31 is not pushed in when the door is closed and the sealing wall 26 is pushed inward by the door glass 11. Consequently, no or very little gap is created between the lip 31 and the garnish 15.

The base 23 of this embodiment is fixed to the body 4 by the retainer 5. However, the base 23 can be fixed to the body 4 by other means such as a two-sided adhesive tape or a clip. Furthermore, the retainer, two-sided adhesive tape, and clip can be used in combination.

The sealing wall 26 of the weatherstrip 21 connects the sidewalls 24 and 25, but may connect the sidewall 24 and the base 23 without the sidewall 25.

In the weatherstrip of this embodiment, when the door is closed, the sealing wall 26 and sealing lip 29 are resiliently pressed against the door glass 11 for double sealing. However, only the sealing wall 26 can be used to seal the door glass 11 without the sealing lip 29.

A weatherstrip 41 shown in FIG. 3 has at the perimeter on the back of the lip 31 a projection 42 having an angled shape in a plane view instead of the aforementioned projection 34. The lip perimeter is supported by the body 4 through the projection 42. The shown projection 42 is provided only at one point. However, multiple projections 42 are provided in another embodiment and multiple groups of projections 42 are further provided in another embodiment.

A weatherstrip 46 shown in FIGS. 4 and 5 has a thicker part 47 instead of forming the projection 34 on the lip 31. The lip perimeter is supported by the body 4 through the thicker part 47.

In a weatherstrip 51 of yet another embodiment shown in FIG. 6, a wall 52 rising from the base 23 and supporting the lip 31 is made thicker than the wall 25 shown in FIG. 2 for increased rigidity. Therefore, the lip 31 shown in FIG. 6 is less easily bent.

What is claimed is:

1. A weatherstrip for a hardtop automobile comprising a molded part that is attached to the corner part of the door opening edge of the body, wherein the molded part has a base that is fixed to the body, sidewall rising from the base, a sealing wall that forms a hollow together with the base and sidewall and is resiliently pressed against the door glass when the door is closed, and a lip that is extended from the sealing wall and inserted between the body and a garnish attached to the body and the projection, ridge, or thicker part that makes contact with the body to support the lip is formed on said lip.

2. The weatherstrip according to claim 1, wherein the wall rising from the base and supporting the lip consists of a wall having an increased rigidity instead of a projection, a ridge, or a thicker part being formed on the lip.
